(19) United States
(12) Patent Application Publication
(10) Pub. No.: US 2025/0321997 A1
(43) Pub. Date: Oct. 16, 2025

(54) SYSTEM AND METHOD FOR SMART PRODUCT RECOMMENDATION

(71) Applicant: DELL PRODUCTS L.P., Round Rock, TX (US)

(72) Inventors: Rongbin Zhang, Chengdu (CN); Lei Wang, Chengdu (CN); Yong Lu, Chengdu (CN)

(21) Appl. No.: 18/787,954

(22) Filed: Jul. 29, 2024

(30) Foreign Application Priority Data
Apr. 15, 2024 (CN) 202410450943.8

(51) Int. Cl. G06F 16/33

(52) U.S. Cl. CPC G06F 16/3332

(57) ABSTRACT

An information handling system receives a query for a product recommendation, converts the query into a first prompt for a large language model, and generates a second prompt to guide the large language model in marking a task for searching auxiliary data according to the query. The system provides the first prompt and the second prompt to the large language model to generate and mark the task for the searching of the auxiliary data, executes the task to obtain the auxiliary data, and provides a third prompt to the large language model to generate a summary of the auxiliary data in response to the third prompt based on the auxiliary data. The system receives the product recommendation from the large language model based on candidate products included in the summary in response to providing a fourth prompt with the candidate products to the large language model.

### FIELD OF THE DISCLOSURE

The present disclosure generally relates to information handling systems, and more particularly relates to a system and method for smart product recommendation.

### BACKGROUND

As the value and use of information continues to increase, individuals and businesses seek additional ways to process and store information. One option is an information handling system. An information handling system generally processes, compiles, stores, or communicates information or data for business, personal, or other purposes. Technology and information handling needs and requirements can vary between different applications. Thus, information handling systems can also vary regarding what information is handled, how the information is handled, how much information is processed, stored, or communicated, and how quickly and efficiently the information can be processed, stored, or communicated. The variations in information handling systems allow information handling systems to be general or configured for a specific user or specific use such as financial transaction processing, airline reservations, enterprise data storage, or global communications. In addition, information handling systems can include a variety of hardware and software resources that can be configured to process, store, and communicate information and can include one or more computer systems, graphics interface systems, data storage systems, networking systems, and mobile communication systems. Information handling systems can also implement various virtualized architectures. Data and voice communications among information handling systems may be via networks that are wired, wireless, or some combination.

### SUMMARY

An information handling system receives a query for a product recommendation, converts the query into a first prompt for a large language model, and generates a second prompt to guide the large language model in marking a task for searching auxiliary data according to the query. The system provides the first prompt and the second prompt to the large language model to generate and mark the task for the searching of the auxiliary data, executes the task to obtain the auxiliary data, and provides a third prompt to the large language model to generate a summary of the auxiliary data in response to the third prompt based on the auxiliary data. The system receives the product recommendation from the large language model based on candidate products included in the summary in response to providing a fourth prompt with the candidate products to the large language model.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram illustrating an information handling system, according to an embodiment of the present disclosure;

FIG. 2 is a block diagram of a system for a smart product recommendation, according to an embodiment of the present disclosure; and

FIGS. 3-5 are flowcharts of methods for a smart product recommendation, according to an embodiment of the present disclosure.

The use of the same reference symbols in different drawings indicates similar or identical items.

### DETAILED DESCRIPTION OF THE DRAWINGS

The following description in combination with the Figures is provided to assist in understanding the teachings disclosed herein. The description is focused on specific implementations and embodiments of the teachings and is provided to assist in describing the teachings. This focus should not be interpreted as a limitation on the scope or applicability of the teachings.

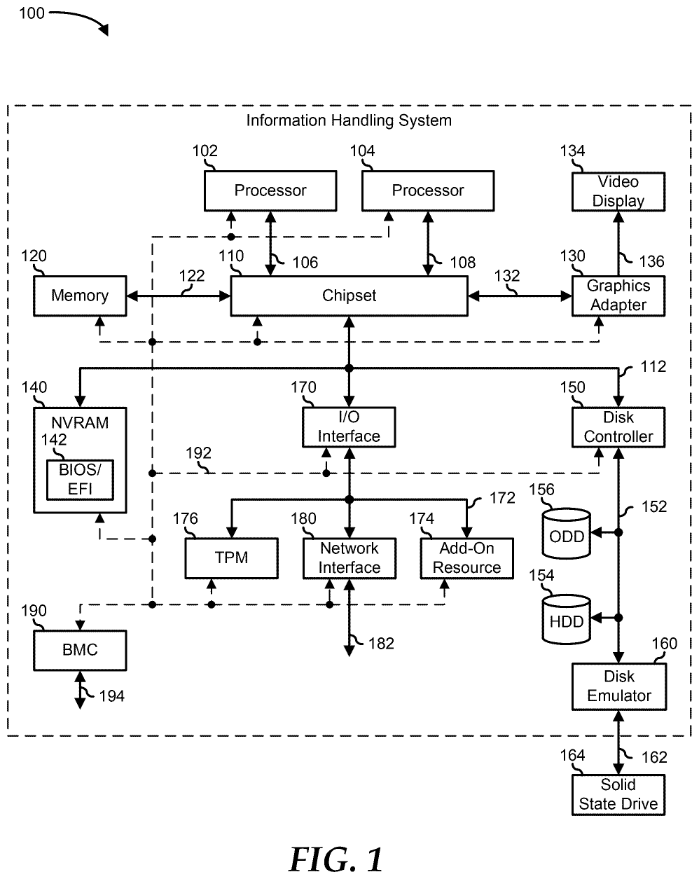

FIG. 1 illustrates an embodiment of an information handling system 100 including processors 102 and 104, a chipset 110, a memory 120, a graphics adapter 130 connected to a video display 134, a non-volatile RAM (NVRAM) 140 that includes a basic input and output system/extensible firmware interface (BIOS/EFI) module 142, a disk controller 150, a hard disk drive (HDD) 154, an optical disk drive 156, a disk emulator 160 connected to a solid-state drive (SSD) 164, an input/output (I/O) interface 170 connected to an add-on resource 174 and a trusted platform module (TPM) 176, a network interface 180, and a baseboard management controller (BMC) 190. Processor 102 is connected to chipset 110 via processor interface 106, and processor 104 is connected to the chipset via processor interface 108. In a particular embodiment, processors 102 and 104 are connected together via a high-capacity coherent fabric, such as a HyperTransport link, a QuickPath Interconnect, or the like. Chipset 110 represents an integrated circuit or group of integrated circuits that manage the data flow between processors 102 and 104 and the other elements of information handling system 100. In a particular embodiment, chipset 110 represents a pair of integrated circuits, such as a northbridge component and a southbridge component. In another embodiment, some or all of the functions and features of chipset 110 are integrated with one or more of processors 102 and 104.

Memory 120 is connected to chipset 110 via a memory interface 122. An example of memory interface 122 includes a Double Data Rate (DDR) memory channel and memory 120 represents one or more DDR Dual In-Line Memory Modules (DIMMs). In a particular embodiment, memory interface 122 represents two or more DDR channels. In another embodiment, one or more of processors 102 and 104 include a memory interface that provides a dedicated memory for the processors. A DDR channel and the connected DDR DIMMs can be in accordance with a particular DDR standard, such as a DDR3 standard, a DDR4 standard, a DDR5 standard, or the like.

Memory 120 may further represent various combinations of memory types, such as Dynamic Random Access Memory (DRAM) DIMMs, Static Random Access Memory (SRAM) DIMMs, non-volatile DIMMs (NV-DIMMs), storage class memory devices, Read-Only Memory (ROM) devices, or the like. Graphics adapter 130 is connected to chipset 110 via a graphics interface 132 and provides a video display output 136 to a video display 134. An example of a graphics interface 132 includes a Peripheral Component Interconnect-Express (PCIe) interface and graphics adapter 130 can include a four-lane (x4) PCIe adapter, an eight-lane (x8) PCIe adapter, a 16-lane (x16) PCIe adapter, or another configuration, as needed or desired. In a particular embodiment, graphics adapter 130 is provided down on a system printed circuit board (PCB). Video display output 136 can include a Digital Video Interface (DVI), a High-Definition Multimedia Interface (HDMI), a DisplayPort interface, or the like, and video display 134 can include a monitor, a smart television, an embedded display such as a laptop computer display, or the like.

NVRAM 140, disk controller 150, and I/O interface 170 are connected to chipset 110 via an I/O channel 112. An example of I/O channel 112 includes one or more point-to-point PCIe links between chipset 110 and each of NVRAM 140, disk controller 150, and I/O interface 170. Chipset 110 can also include one or more other I/O interfaces, including a PCIe interface, an Industry Standard Architecture (ISA) interface, a Small Computer Serial Interface (SCSI) interface, an Inter-Integrated Circuit (I²C) interface, a System Packet Interface, a Universal Serial Bus (USB), another interface, or a combination thereof. NVRAM 140 includes BIOS/EFI module 142 that stores machine-executable code (BIOS/EFI code) that operates to detect the resources of information handling system 100, to provide drivers for the resources, to initialize the resources, and to provide common access mechanisms for the resources. The functions and features of BIOS/EFI module 142 will be further described below.

Disk controller 150 includes a disk interface 152 that connects the disc controller to a hard disk drive (HDD) 154, to an optical disk drive (ODD) 156, and to disk emulator 160. An example of disk interface 152 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 160 permits SSD 164 to be connected to information handling system 100 via an external interface 162. An example of external interface 162 includes a USB interface, an institute of electrical and electronics engineers (IEEE) 1394 (Firewire) interface, a proprietary interface, or a combination thereof. Alternatively, SSD 164 can be disposed within information handling system 100.

I/O interface 170 includes a peripheral interface 172 that connects the I/O interface to add-on resource 174, to TPM 176, and to network interface 180. Peripheral interface 172 can be the same type of interface as I/O channel 112 or can be a different type of interface. As such, I/O interface 170 extends the capacity of I/O channel 112 when peripheral interface 172 and the I/O channel are of the same type, and the I/O interface translates information from a format suitable to the I/O channel to a format suitable to the peripheral interface 172 when they are of a different type. Add-on resource 174 can include a data storage system, an additional graphics interface, a network interface card (NIC), a sound/video processing card, another add-on resource, or a combination thereof. Add-on resource 174 can be on a main circuit board, on separate circuit board, or add-in card disposed within information handling system 100, a device that is external to the information handling system, or a combination thereof.

Network interface 180 represents a network communication device disposed within information handling system 100, on a main circuit board of the information handling system, integrated onto another component such as chipset 110, in another suitable location, or a combination thereof. Network interface 180 includes a network channel 182 that provides an interface to devices that are external to information handling system 100. In a particular embodiment, network channel 182 is of a different type than peripheral interface 172 and network interface 180 translates information from a format suitable to the peripheral channel to a format suitable to external devices.

In a particular embodiment, network interface 180 includes a NIC or host bus adapter (HBA), and an example of network channel 182 includes an InfiniBand channel, a Fibre Channel, a Gigabit Ethernet channel, a proprietary channel architecture, or a combination thereof. In another embodiment, network interface 180 includes a wireless communication interface, and network channel 182 includes a Wi-Fi channel, a near-field communication (NFC) channel, a Bluetooth® or Bluetooth-Low-Energy (BLE) channel, a cellular based interface such as a Global System for Mobile (GSM) interface, a Code-Division Multiple Access (CDMA) interface, a Universal Mobile Telecommunications System (UMTS) interface, a Long-Term Evolution (LTE) interface, or another cellular based interface, or a combination thereof. Network channel 182 can be connected to an external network resource (not illustrated). The network resource can include another information handling system, a data storage system, another network, a grid management system, another suitable resource, or a combination thereof.

BMC 190 is connected to multiple elements of information handling system 100 via one or more management interface 192 to provide out of band monitoring, maintenance, and control of the elements of the information handling system. As such, BMC 190 represents a processing device different from processor 102 and processor 104, which provides various management functions for information handling system 100. For example, BMC 190 may be responsible for power management, cooling management, and the like. The term BMC is often used in the context of server systems, while in a consumer-level device, a BMC may be referred to as an embedded controller (EC). A BMC included in a data storage system can be referred to as a storage enclosure processor. A BMC included at a chassis of a blade server can be referred to as a chassis management controller and embedded controllers included at the blades of the blade server can be referred to as blade management controllers. Capabilities and functions provided by BMC 190 can vary considerably based on the type of information handling system. BMC 190 can operate in accordance with an Intelligent Platform Management Interface (IPMI). Examples of BMC 190 include an Integrated Dell® Remote Access Controller (iDRAC).

Management interface 192 represents one or more out-of-band communication interfaces between BMC 190 and the elements of information handling system 100, and can include an Inter-Integrated Circuit (I2C) bus, a System Management Bus (SMBUS), a Power Management Bus (PMBUS), a Low Pin Count (LPC) interface, a serial bus such as a Universal Serial Bus (USB) or a Serial Peripheral Interface (SPI), a network interface such as an Ethernet interface, a high-speed serial data link such as a PCIe interface, a Network Controller Sideband Interface (NC-SI), or the like. As used herein, out-of-band access refers to operations performed apart from a BIOS/operating system execution environment on information handling system 100, that is apart from the execution of code by processors 102 and 104 and procedures that are implemented on the information handling system in response to the executed code.

BMC 190 operates to monitor and maintain system firmware, such as code stored in BIOS/EFI module 142, option ROMs for graphics adapter 130, disk controller 150, add-on resource 174, network interface 180, or other elements of information handling system 100, as needed or desired. In particular, BMC 190 includes a network interface 194 that can be connected to a remote management system to receive firmware updates, as needed or desired. Here, BMC 190 receives the firmware updates, stores the updates to a data storage device associated with the BMC, and transfers the firmware updates to the NVRAM of the device or system that is the subject of the firmware update, thereby replacing the currently operating firmware associated with the device or system, and reboots information handling system, whereupon the device or system utilizes the updated firmware image.

BMC 190 utilizes various protocols and application programming interfaces (APIs) to direct and control the processes for monitoring and maintaining the system firmware. An example of a protocol or API for monitoring and maintaining the system firmware includes a graphical user interface (GUI) associated with BMC 190, an interface defined by the Distributed Management Taskforce (DMTF) (such as a Web Services Management (WSMan) interface, a Management Component Transport Protocol (MCTP) or, a Redfish® interface), various vendor defined interfaces (such as a Dell EMC Remote Access Controller Administrator (RACADM) utility, a Dell EMC OpenManage Enterprise, a Dell EMC OpenManage Server Administrator (OMSA) utility, a Dell EMC OpenManage Storage Services (OMSS) utility, or a Dell EMC OpenManage Deployment Toolkit (DTK) suite), a BIOS setup utility such as invoked by a “F2” boot option, or another protocol or API, as needed or desired.

In a particular embodiment, BMC 190 is included on a main circuit board (such as a baseboard, a motherboard, or any combination thereof) of information handling system 100 or is integrated onto another element of the information handling system such as chipset 110, or another suitable element, as needed or desired. As such, BMC 190 can be part of an integrated circuit or a chipset within information handling system 100. An example of BMC 190 includes an iDRAC, or the like. BMC 190 may operate on a separate power plane from other resources in information handling system 100. Thus BMC 190 can communicate with the management system via network interface 194 while the resources of information handling system 100 are powered off. Information can be sent from the management system to BMC 190 and the information can be stored in a RAM or NVRAM associated with the BMC. Information stored in the RAM may be lost after power-down of the power plane for BMC 190, while information stored in the NVRAM may be saved through a power-down/power-up cycle of the power plane for the BMC.

Information handling system 100 can include additional components and additional busses, not shown for clarity. For example, information handling system 100 can include multiple processor cores, audio devices, and the like. While a particular arrangement of bus technologies and interconnections is illustrated for the purpose of example, one of skill will appreciate that the techniques disclosed herein are applicable to other system architectures. Information handling system 100 can include multiple central processing units (CPUs) and redundant bus controllers. One or more components can be integrated together. Information handling system 100 can include additional buses and bus protocols, for example, I2C and the like. Additional components of information handling system 100 can include one or more storage devices that can store machine-executable code, one or more communications ports for communicating with external devices, and various input and output (I/O) devices, such as a keyboard, a mouse, and a video display.

For purposes of this disclosure information handling system 100 can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, information handling system 100 can be a personal computer, a laptop computer, a smartphone, a tablet device or other consumer electronic device, a network server, a network storage device, a switch, a router, or another network communication device, or any other suitable device and may vary in size, shape, performance, functionality, and price. Further, information handling system 100 can include processing resources for executing machine-executable code, such as processor 102, a programmable logic array (PLA), an embedded device such as a System-on-a-Chip (SoC), or other control logic hardware. Information handling system 100 can also include one or more computer-readable media for storing machine-executable code, such as software or data.

When a customer uses a manufacturer's product portal to search for a computing system or other items like a gaming computer, a headset, a mouse, etc., the customer typically describes his needs using natural language. However, a typical product portal may require the user to provide a precise product name or specific configuration to provide a relevant product recommendation. For example the product portal may require a CPU model, graphics processing unit model, etc. As such the typical product portal assumes that the user has a degree of familiarity with the product he or she is searching for, which may not be true. Thus, it would be desirable for the product portal to provide a relevant product recommendation without the user specifying a product name or a specific configuration or properties. To address this issue and other concerns, the present disclosure provides a system and method for smart product recommendations that allow the product portal to interact with the user in a more user-friendly manner.

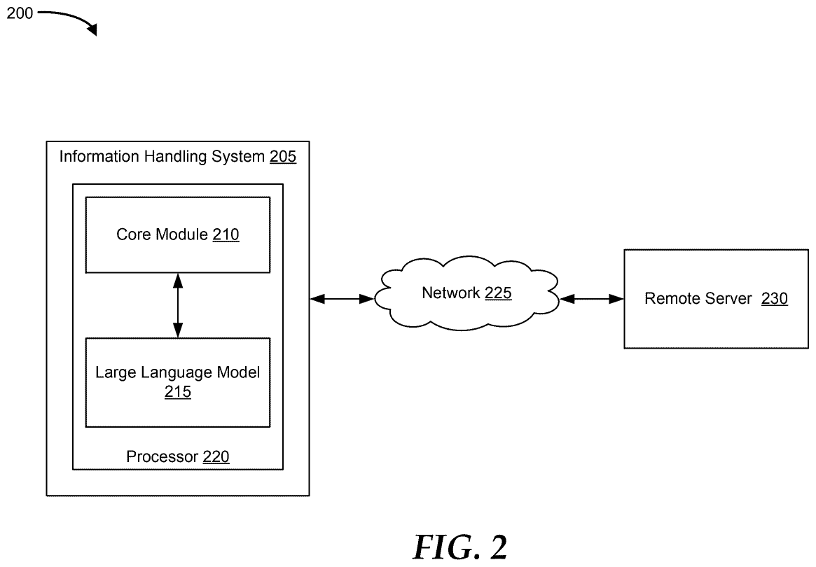

FIG. 2 shows a system 200 for smart product recommendations. System 200 includes an information handling system 205, a network 225, and a remote server 230. Information handling system 205, which is similar to information handling system 100 of FIG. 1, includes a processor 220, which is similar to processors 102 and 104 of FIG. 1, that may be configured to execute a core module 210 and a large language model (LLM) 215. Core module 210 may be communicatively coupled to LLM 215. Information handling system 205 may be communicatively coupled with remote server 230 via network 225. However, any variety of connections between components of information handling system 205 and between information handling system 205 and remote server 230 are envisioned as falling within the scope of the present disclosure. The components of system 200 may be implemented in hardware, software, firmware, or any combination thereof. The components shown are not drawn to scale and system 200 may include additional or fewer components. In addition, connections between components of system 200 may be omitted for descriptive clarity.

System 200 may be used to provide an answer, such as one or more product recommendations based on the user's query, where system 200 may be configured to support multiple natural languages including a hybrid language. If the user's query is provided to a machine learning model, such as LLM 215, in its original form, the machine learning model may not be able to provide the answer desired by the user. Accordingly, system 200 may be configured to design prompts based on the original query of the user that can guide the machine learning model to the answer.

In one embodiment, core module 210 can be an engine behind a manufacturer's product portal, wherein core module 210 may be configured to design one or more prompts that may guide LLM 215 to provide an answer to a user's query provided at the portal. In one embodiment, core module 210 may design a first prompt based on the query to set a context and clarify a persona associated with the query. The first prompt may also include an inference associated with an implicit requirement of the query. Core module 210 may also generate a second prompt and a third prompt to be used by LLM 215 for in-context learning. In particular, the second prompt may be used for zero-shot prompting to guide LLM 215 in identifying whether real-time content is needed or desired to answer the query. The third prompt may be used for few-shot prompting to guide LLM 215 in composing one or more tasks according to a specified format.

For example, the third prompt may be used to train LLM 215 to mark a task using a task delimiter, a task keyword, and a task description. In a particular example, a “{}” may be used as the task delimiter while “SCH” and “DB” may be used as task keywords, wherein the task keyword SCH may indicate a network task to search online for real-time data, such as by using remote server 230. On the other hand task keyword DB may indicate a task for a local database query. For example, with an input: I need the fastest CPU model, LLM 215 may generate an output with a format: I need {SCH: the fastest CPU currently}. Core module 210 may also be configured to identify and execute the tasks marked by LLM 215. For example, core module 210 may execute a network task to perform an online search for the fastest CPU.

Core module 210 may be configured to design another prompt to guide LLM 215 to summarize and organize the auxiliary data, such as real-time data obtained during the online search. A summary of the auxiliary data received from LLM 215 includes candidate products and a set of criteria to select a product recommendation to answer the user's query. Further, core module 210 may be configured to generate a prompt that includes the candidate products and the criteria to guide LLM 215 in selecting a relevant product recommendation from the candidate products according to the criteria.

LLM 215 may be a language model, such as generative pre-trained transformer 3 (GPT-3), a GPT-3.5, a GPT-4, or similar. Typically, LLMs are trained in large collections of natural language source documents. Accordingly, the LLMs, such as LLM 215 may be designed to interpret natural language and generate a text response to a prompt provided. Remote server 230 may host a search engine for real-time information queries via network 225. In another example, remote server 230 may host a cloud-based application that can provide a service to information handling system 205 via network 225.

Network 225 may be implemented as or maybe a part of, a storage area network (SAN), a personal area network (PAN), a local area network (LAN), a metropolitan area network (MAN), a wide area network (WAN), a wireless local area network (WLAN), a virtual private network (VPN), an intranet, the Internet, or any other appropriate architecture or system that facilitates the communication of signals, data and/or messages. Network 225 may transmit data using any storage and/or communication protocol, including without limitation, Fibre Channel, Frame Relay, Asynchronous Transfer Mode (ATM), Internet Protocol (IP), other packet-based protocol, SCSI, Internet SCSI (iSCSI), Serial Attached SCSI (SAS), or any other transport that operates with the SCSI protocol, ATA, SATA, advanced technology attachment packet interface (ATAPI), serial storage architecture (SSA), integrated drive electronics (IDE), and/or any combination thereof. Network 225 and its various components may be implemented using hardware, software, or any combination thereof. These components may be configured to facilitate communication between information handling system 205, and remote server 230.

Those of ordinary skill in the art will appreciate that the configuration, hardware, and/or software components of system 200 depicted in FIG. 2 may vary. For example, the illustrative components within system 200 are not intended to be exhaustive but rather are representative to highlight components that can be utilized to implement aspects of the present disclosure. For example, other devices and/or components may be used in addition to or in place of the devices/components depicted. The depicted example does not convey or imply any architectural or other limitations with respect to the presently described embodiments and/or the general disclosure. In the discussion of the figures, reference may also be made to components illustrated in other figures for continuity of the description.

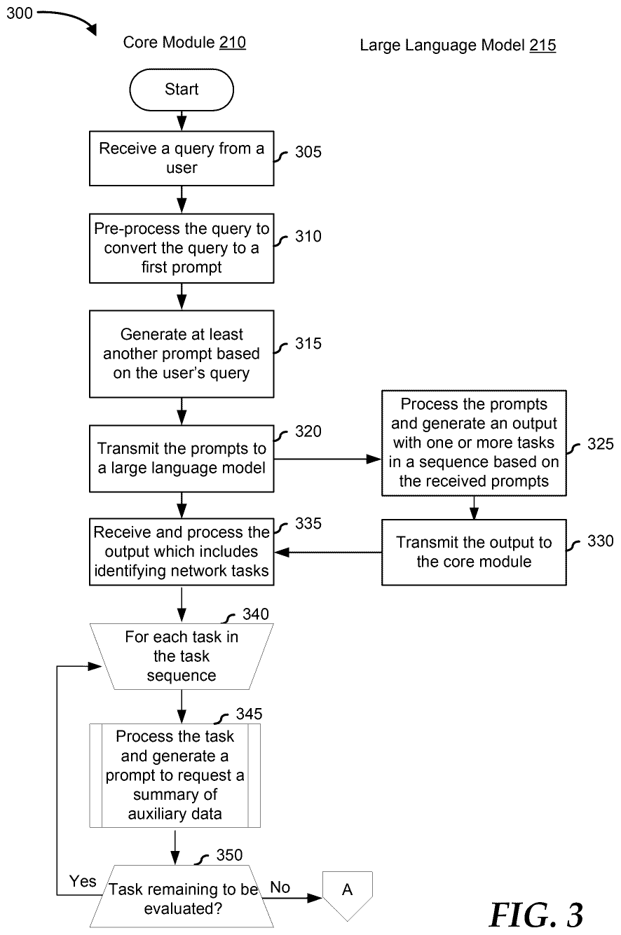

FIG. 3 shows a flowchart of a method 300 for smart product recommendations. Method 300 may be performed by any suitable component of system 200 including, but not limited to, core module 210, LLM 215, and remote server 230 of FIG. 2. While embodiments of the present disclosure are described in terms of the components of system 200 of FIG. 2, it should be recognized that other components may be utilized to perform the described method. One of skill in the art will appreciate that this sequence diagram explains a typical example, which can be extended to applications or services in practice.

Method 300 typically starts at block 305, where core module 210 may receive a query from a user. For example, the query received may be “I want to buy a computer to play the most popular 3D PC games currently.” The method may proceed to block 310, where core module 210 may pre-process the query which includes converting the query to a first prompt. Typically, the user's request may not include specific configuration information. Instead, the user's request may have vague references or purchase tendencies. In addition, the user's request is generally an incomplete sentence that may have implicit information. For example, if a user is searching for a product using a product portal of a manufacturer, then the user may intend to buy products made by the manufacturer. Thus, the user's request may have an implicit context for recommendations of products by that manufacturer. However, LLM 215 may not understand the user's intention if the request is provided to LLM 215 in its original format. Accordingly, converting the request to a first prompt that LLM 215 may understand may be desirable.

The prompt may include information associated with the implicit context if any. As such, the first prompt may set an inference context, clarify the user's intention, and guide LLM 215 on how to break down the user's request into sub-problems or tasks for a chain-of-thought inference. In one embodiment, the first prompt may include a persona, an inference context, a guideline, and the user's request. The persona may be a linguistic description of the LLM's identity. The persona may confine the reasoning of LLM 215 within at least one specific domain of knowledge. The inference context may indicate one or more specific constraints to be accounted for when selecting one or more products for recommendation. In this example, the recommendation may be limited to a manufacturer based on the implicit information. The guideline may be a series of instructions used to guide LLM 215 in generating one or more task plans for the chain-of-thought inference. The user's request may include the original query provided by the user.

Assuming that the manufacturer whose product portal is used for the query is Dell, based on the user's query above, the first prompt may be “[a]s a computer expert, you need to recommend a Dell computer to the customer according to the requirement. What issues do you need to consider? The customer's request is a computer to play the most popular 3D PC games.” In this example, the persona is indicated as a computer expert while the inference context limits the recommendation to Dell. Further, the guideline for LLM 215 is indicated as “[w]hat issues do you need to consider.”

The method proceeds to block 315 where core module 210 may generate at least two additional prompts based on the user's query. Because LLM 215 may not be able to provide auxiliary data, such as real-time data, a task to obtain real-time data may be needed or desired. These prompts may be selected as the most relevant prompts from a dataset or a database of prompts associated with auxiliary data retrieval for LLM 215. The prompts may also be automatically generated by a prompting LLM. In this example, core module 210 may select a first prompt and a second prompt from a dataset of relevant prompts. The first prompt may be used in zero-shot prompting to guide LLM 215 to identify auxiliary content associated with the user's query that may be needed or desired. The second prompt may be used to train LLM 215 via few-shot prompting to mark the content to determine what to search for when real-time data is needed or desired according to a specified format. Examples of the first prompt are shown below:
a. What words in a sentence can you infer that real-time data is needed to answer the question?”
b. In the following question, if your answer needs support from online data, you should have the ability to identify them.

An example of the second prompt is shown below:
a. When real-time data is not needed, tell me the answer directly. But when real-time data is needed, you must tell me the real-time content that needs to be queried online in the following format:
   i. Input: I need the fastest CPU model.
   ii. Output: I need {SCH: the fastest CPU currently}.
   iii. Input: I want to know the best CPU and the fastest GPU.
   iv. Output: I need {SCH: the best CPU currently} and {SCH: the fastest GPU currently}.

In this example, the text enclosed by “{SCH: insert text here}” may guide LLM 215 to mark content with the task delimiter and keyword: {SCH: } when the auxiliary data is needed or desired. The method proceeds to block 320, where core module 210 may transmit the first prompt generated in block 305 and the one or more prompts generated in block 310 to LLM 215. At block 325, LLM 215 may receive, analyze, and process the prompts from core module 210, wherein LLM 215 may use in-context learning in processing the prompt from block 310. LLM 215 may return an output that includes a series of executable task sequences, wherein a task may also include a subtask. An example of the output is shown below.
a. Task 1: Determine the {SCH: Recommended hardware configuration for the most popular games currently} to select a suitable computer.
b. Task 2: Consider {SCH: Dell computer configurations}. Ensure that the CPU meets or exceeds the recommended specifications of the games.

The method proceeds to block 330, where LLM 215 may transmit the output to core module 210. Because LLM 215 cannot provide real-time data, a task to access and obtain the auxiliary data may be needed or desired, wherein auxiliary data includes real-time data. For example, a task may obtain real-time data online using a search engine. The said task may be part of the series of executable task sequences, wherein a task may include a subtask. LLM 215 may provide information on what network operations if any are required to obtain the auxiliary data, such as to access remote server 230. In particular, the second prompt may allow LLM 215 to mark one or more network tasks among a sequence of tasks according to a format specified by core module 210, such as shown in the tasks included in the output returned by LLM 215 above.

The method proceeds to block 335, core module 210 may receive and process the output from LLM 215. Processing the output includes identifying tasks that may be used to obtain auxiliary data, also referred to as network tasks. Because LLM 215 may have marked the network tasks in the task sequence according to the specified format, core module 210 may identify one or more network tasks according to their marking and initiate a network service call to obtain the auxiliary data. For example, core module 210 may identify the network tasks according to a format provided at block 315. For example, core module 210 may parse the output received from LLM 215 to search for one or more keywords, delimiters, task descriptors, etc. In one particular example, core module 210 may parse for “{}” and/or “SCH” or a combination thereof among others. Based on the example above, core module 210 may identify tasks 1 and 2 above as network tasks.

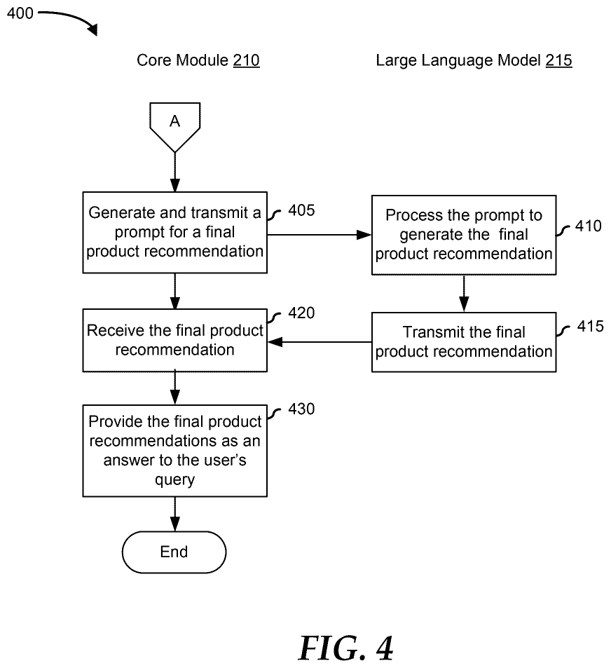

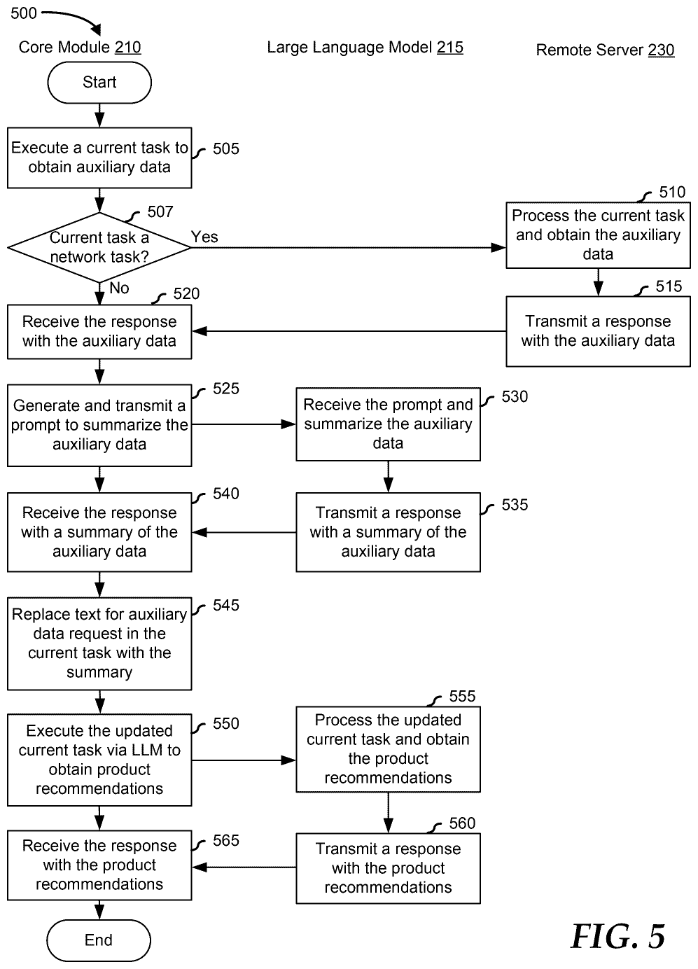

The method proceeds to block 340 where core module 210 may traverse the task sequence to evaluate each task. The task that is currently being evaluated is herein referred to as a current task. The method proceeds to block 345, where core module 210 may process the current task and generate a prompt to request a summary of the auxiliary data, as shown in a method 500 of FIG. 5. The method proceeds to block 350 where core module 210 may determine if there is a task in the task sequence to be processed. If there is a task to be processed, then the “YES” branch is taken, and the method proceeds to block 340. If there is no more task to be processed, then the “NO” branch is taken, and the method proceeds to block 405 of FIG. 4.

FIG. 4 shows a flowchart of a method 400 which is a continuation of method 300 of FIG. 3. Method 400 typically starts at block 405 where core module 210 may generate and transmit a prompt for LLM 215 to provide a final product recommendation based on the product recommendations from each updated network task. The prompt may be a concatenation of the user's query plus a guideline and the product recommendations from block 345 of FIG. 3. The product recommendations may include one or more candidate products and a set of criteria. The set of criteria may include a minimum configuration of the candidate products. Accordingly, the final product recommendation may be at least one of the candidate products that meets or exceeds the set of criteria. An example of the prompt is shown below, where “I want to buy a computer for playing the most popular 3D PC games currently” is the user's query and “[r]ecommend the most suitable computer based on the content as follows” is the guideline and followed by a set of criteria and candidate products.
a. Prompt: I want to buy a computer for playing the most popular 3D PC games currently. Recommend the most suitable computer based on the content as follows. CPU: Intel Core i5™-8400H, GPU: Nvidia Geforce GTX™ 1060, RAM: 2 x Colorful CVN Guardian 8 GB DDR4-3200, Hard Drive: WD Green 2 TB HDD, Operating System: Windows 10 64-bit.
   The Dell™ G16 gaming laptop features a 13th Gen Intel Core i7™-13650HX processor, NVIDIA Geforce RTX™ 4050 GPU, 16 GB DDR5 RAM, and a 1 TB PCIe NVMe SSD. It has a 16″ QHD+240 Hz display with NVIDIA G-SYNC and comes with a US English 1-Zone RGB backlit keyboard. The laptop offers a range of ports including Thunderbolt™ 4, USB 3.2, HDMI 2.1, and RJ45 Ethernet. It has a metallic Nightshade chassis, Intel Wi-Fi 6 AX201, and a 6-cell 86 Wh battery. The Dell™ G16 weighs 6.3 pounds and comes with Windows 11 Home pre-installed.

Add other candidate products here.

In the above prompt, an example of a candidate product and a criterion are shown below:
a. Candidate Product: The Dell™ G16 gaming laptop features a 13th Gen Intel Core i7-13650HX processor, NVIDIA™ GeForce RTX 4050 GPU, 16 GB DDR5 RAM, and a 1 TB PCIe NVMe SSD. It has a 16″ QHD+240 Hz display with NVIDIA G-SYNC and comes with a US English 1-Zone RGB backlit keyboard. The laptop offers a range of ports including Thunderbolt™ 4, USB 3.2, HDMI 2.1, and RJ45 Ethernet. It has a metallic Nightshade chassis, Intel Wi-Fi 6 AX201, and a 6-cell 86 battery. The Dell™ G16 weighs 6.3 pounds and comes with Windows™ 11 Home pre-installed.
b. Criterion: CPU: Intel Core i5™-8400H, GPU: Nvidia Geforce GTX™ 1060, RAM: 2 x Colorful CVN Guardian 8 GB DDR4-3200, Hard Drive: WD Green 2 TB HDD, Operating System: Windows™ 10 64-bit.

At block 410, LLM 215 may process the prompt and generate the final product recommendation based on the candidate products and the set of criteria. The final recommendation may have the same or higher computing capability included in the set of criteria. An example of the final product recommendation is shown below:
a. When purchasing a computer for gaming, especially for playing the most popular 3D PC games currently, I recommend Dell's Alienware™ and G-Series™ PCs, as they are well-known for their gaming capabilities, because:
   1). Powerful Hardware: Alienware™ and G-Series™ systems often come equipped with high-performance components such as powerful graphics cards (NVIDIA GeForce or AMD Radeon), fast processors (Intel Core i7™ or AMD Ryzen™), ample RAM (typically 16 GB or more), and spacious storage options (SSD and HDD combinations).
   2). Customization Options: These product lines usually offer customization options, allowing users to tailor their PCs to meet their specific gaming needs. You can often choose different configurations for graphics cards, processors, RAM, and storage to optimize performance for 3D gaming.
   3). Cooling Systems: To ensure smooth and uninterrupted gameplay, both Alienware™ and G-Series™ desktops employ advanced cooling systems. These systems help maintain optimal temperatures during intensive gaming sessions, preventing overheating and performance throttling.
   4). Brand Reputation and Support: Dell™ is a well-established and reputable brand in the computer industry, known for its quality products and reliable customer support. Choosing a gaming PC from Alienware™ or the G-Series™ provides assurance of good build quality, warranty coverage, and access to customer service if needed.

The method proceeds to block 415 where LLM 215 may transmit the final product recommendation to core module 210. At block 420, core module 210 may receive the final product recommendation from LLM 215. The method proceeds to block 430 where core module 210 may provide the final product recommendation as an answer to the user's query. Afterwards, the method ends.

FIG. 5 shows a flowchart of method 500 for processing tasks received as output from LLM 215. In particular, method 500 provides details associated with block 345 of FIG. 3. Method 500 may be performed by any suitable component of system 200 including, but not limited to, core module 210, LLM 215, and remote server 230 of FIG. 2. While embodiments of the present disclosure are described in terms of the components of system 200 of FIG. 2, it should be recognized that other components may be utilized to perform the described method. One of skill in the art will appreciate that this sequence diagram explains a typical example, which can be extended to applications or services in practice.

Method 500 typically starts at block 505 where core module 210 may execute a current task. The method may proceed to decision block 507 where core module 210 may determine whether the current task is a network task. If the current task is a network task, then the “YES” branch is taken, and the method proceeds to block 510. If the current task is not a network task, then the “NO” branch is taken, and the method proceeds to block 520. If the current task is a network task, then core module 210 may initiate a network service call to obtain the auxiliary data. If an internet search is needed or desired, core module 210 may initiate a call to a search engine using the search keywords provided by LLM 215 to obtain real-time data. In another example, if the manufacturer's product information is needed or desired as indicated by the manufacturer's name in the current task, then core module 210 may retrieve the product-related data from the manufacturer's product portal.

At block 510, remote server 230 may process the current task to obtain the auxiliary data. In one particular example, the auxiliary data may include web page contents with one or more recommended computer configurations from the manufacturer's product portal. The method proceeds to block 515 where remote server 230 may transmit a response with the auxiliary data to core module 210. At block 520, core module 210 may receive the response along with the auxiliary data.

The method proceeds to block 525 where core module 210 may generate a prompt to summarize and organize the auxiliary data. In one embodiment, the prompt may include a guideline to generate a summary of the auxiliary data. In one example, the guideline may include texts similar to “[e]xtract a summary of” and “based on the text context below.” The task descriptor may include “the recommended hardware configuration for the most popular 3D PC games currently.” Core module 210 may extract text content of the auxiliary data and the prompt may include the extracted text content of the auxiliary data. An example of the prompt based on task 1 from block 325 is shown below.
a. Task 1: Determine the {SCH: Recommended hardware configuration for the most popular games currently} to select a suitable computer.
b. Prompt: Extract a summary of the recommended hardware configuration for the most popular 3D PC games currently based on the text content below. Add the text content of the auxiliary data here.

At block 530, LLM 215 may receive the prompt with the auxiliary data from core module 210. LLM 215 may then process the prompt and summarize the auxiliary data. Afterward, LLM 215 may transmit a response that includes a summary of the auxiliary data to core module 210 at block 535. Core module 210 may receive the response that includes the summary at block 540. At block 545, core module 210 may replace auxiliary data request text in the task with the summary. For example, if the network task is below, then the task data inside the search portion of the network task as marked may be replaced with the summary data.
a. Task 1: Determine the {SCH: Recommended hardware configuration for the most popular games currently} to select a suitable computer.
b. Updated Task 1: Determine the insert a first summary here to select a suitable computer.
c. Task 2: Consider {SCH: Dell computer configurations}. Ensure that the CPU meets or exceeds the recommended specifications of the games.
d. Updated Task 2: Consider insert a second summary here. Ensure that the CPU meets or exceeds the recommended specifications of the games.

After updating the network task in the task sequence, core module 210 may use the updated network task as a prompt at block 550 to obtain product recommendations. For example, each updated task may result in an output that includes a set of product recommendations that includes one or more candidate products and a set of criteria. At block 555, LLM 215 may process the updated task and obtain the product recommendations, which it transmits to core module 210 at block 560. At block 565, core module 210 may receive the product recommendations. The set of criteria and the candidate products may be used to determine a final product recommendation at method 400 of FIG. 4. The method ends.

The term “user” in this context should be understood to encompass, by way of example and without limitation, a user device, a person utilizing or otherwise associated with the device, or a combination of both. An operation described herein as being performed by a user may therefore be performed by a user device, or by a combination of both the person and the device.

Although FIG. 3, FIG. 4, and FIG. 5 show example blocks of method 300, method 400, and method 500 in some implementations, method 300, method 400, and method 500 may include additional blocks, fewer blocks, different blocks, or differently arranged blocks than those depicted in FIG. 3, FIG. 4, and FIG. 5. Those skilled in the art will understand that the principles presented herein may be implemented in any suitably arranged processing system. Additionally, or alternatively, two or more of the blocks of method 300, method 400, and method 500 may be performed in parallel. For example, blocks 310 and 315 of method 300 may be performed in parallel.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionalities as described herein.

When referred to as a “device,” a “module,” a “unit,” a “controller,” or the like, the embodiments described herein can be configured as hardware. For example, a portion of an information handling system device may be hardware such as, for example, an integrated circuit (such as an Application Specific Integrated Circuit (ASIC), a Field Programmable Gate Array (FPGA), a structured ASIC, or a device embedded on a larger chip), a card (such as a Peripheral Component Interface (PCI) card, a PCI-express card, a Personal Computer Memory Card International Association (PCMCIA) card, or other such expansion card), or a system (such as a motherboard, a system-on-a-chip (SoC), or a stand-alone device).

The present disclosure contemplates a computer-readable medium that includes instructions or receives and executes instructions responsive to a propagated signal; so that a device connected to a network can communicate voice, video, or data over the network. Further, the instructions may be transmitted or received over the network via the network interface device.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes, or another storage device to store information received via carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

Although only a few exemplary embodiments have been described in detail above, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents but also equivalent structures.

1. A method comprising:
receiving, by a processor, a query for a product recommendation;
converting the query into a first prompt for a large language model;
generating a second prompt to guide the large language model in marking content with a task delimiter for searching auxiliary data according to the query;
providing the first prompt and the second prompt to the large language model to generate a task sequence, wherein the task sequence includes a task for the searching of the auxiliary data based on the task delimiter, and wherein the task for the searching of the auxiliary data includes a network service call;
processing the task sequence to determine the task that includes the network service call;
executing the task to obtain the auxiliary data, wherein the task includes initiating the network service call;
providing a third prompt to the large language model to generate a summary of the auxiliary data in response to the third prompt based on the auxiliary data;
providing a fourth prompt with candidate products based on the summary to the large language model to generate the product recommendation in response to the fourth prompt; and
providing the product recommendation in response to the query.

2. The method of claim 1, wherein the fourth prompt further includes a criterion.

3. The method of claim 1, wherein the third prompt provided to the large language model includes text content from the auxiliary data.

4. The method of claim 1, further comprising providing the product recommendation as an answer to the query.

5. The method of claim 1, wherein the fourth prompt includes a criterion from the summary.

6. The method of claim 1, wherein the first prompt includes a persona.

7. The method of claim 1, wherein the first prompt includes an inference context based on an implicit requirement of the query.

8. An information handling system, comprising:
a processor; and
a memory storing instructions that when executed cause the processor to perform operations including:
receiving a query for a product recommendation;
converting the query into a first prompt for a large language model;
generating a second prompt to guide the large language model in marking content with a task delimiter for searching auxiliary data according to the query;
providing the first prompt and the second prompt to the large language model to generate a task sequence, wherein the task sequence includes a task for the searching of the auxiliary data based on the task delimiter, and wherein the task for the searching of the auxiliary data includes a network service call;
processing the task sequence to determine the task that includes the network service call;
executing the task to obtain the auxiliary data, wherein the task includes initiating the network service call;
providing a third prompt to the large language model to generate a summary of the auxiliary data in response to the third prompt based on the auxiliary data;
receiving the product recommendation from the large language model based on candidate products included in the summary in response to providing a fourth prompt with the candidate products to the large language model; and
providing the product recommendation in response to the query.

9. The information handling system of claim 8, wherein the summary further includes a criterion.

10. The information handling system of claim 8, wherein the third prompt provided to the large language model includes text content from the auxiliary data.

11. The information handling system of claim 8, further comprising providing the product recommendation as an answer to the query.

12. The information handling system of claim 8, wherein the fourth prompt includes a criterion from the summary.

13. The information handling system of claim 8, wherein the first prompt includes a persona.

14. The information handling system of claim 8, wherein the first prompt includes an inference context based on an implicit requirement of the query.

15. A non-transitory computer-readable medium to store instructions that are executable to perform operations comprising:
receiving a query for a product recommendation;
converting the query into a first prompt for a large language model;
generating a second prompt to guide the large language model in marking content with a task delimiter for searching auxiliary data according to the query;
providing the first prompt and the second prompt to the large language model to generate a task sequence, wherein the task sequence includes a task for the searching of the auxiliary data based on the task delimiter, and wherein the task for the searching of the auxiliary data includes a network service call;
processing the task sequence to determine the task that includes the network service call;
executing the task to obtain the auxiliary data, wherein the task includes initiating the network service call;
providing a third prompt to the large language model to generate a summary of the auxiliary data in response to the third prompt based on the auxiliary data;
receiving the product recommendation from the large language model based on candidate products included in the summary in response to providing a fourth prompt with the candidate products to the large language model; and
providing the product recommendation in response to the query.

16. The non-transitory computer-readable medium of claim 15, wherein the summary further includes a criterion.

17. The non-transitory computer-readable medium of claim 15, wherein the third prompt provided to the large language model includes text content from the auxiliary data.

18. The non-transitory computer-readable medium of claim 15, wherein the fourth prompt includes a criterion from the summary.

19. The non-transitory computer-readable medium of claim 15, wherein the first prompt includes a persona.

20. The non-transitory computer-readable medium of claim 15, wherein the first prompt includes an inference context based on an implicit requirement of the query.
